(19) United States
(12) Patent Application Publication
(10) Pub. No.: US 2008/0095604 A1
(43) Pub. Date: Apr. 24, 2008

(54) Automatic Storage and Discharge Apparatus for Sheet

(76) Inventor: Jae Hyung Jeon, Seoul (KR)

Correspondence Address: RABIN & Berdo, PC, 1101 14TH STREET, NW, SUITE 500, WASHINGTON, DC, 20005, US

(21) Appl. No.: 11/721,750

(22) PCT Filed: Dec. 15, 2005
(86) PCT No.: PCT/KR05/04330

§ 371 Date: Jun. 14, 2007

(30) Foreign Application Priority Data
Dec. 16, 2004 (KR) 10-2004-0106951

(51) Int. Cl. B65G 57/112

(52) U.S. Cl. 414/794.5

(57) ABSTRACT

Provided is an apparatus for automatically supplying and discharging a sheet material. The apparatus includes: a moving frame including a plurality of legs facing one another and traveling along an x-axis guide line and a y-axis guide line; a lifting bar installed at each of the legs for being risen and fallen; and a holder disposed at the lifting bar for lifting up the sheet material. The apparatus effectively loads and discharges various sheet materials having different sizes without regarding to the order of loading the sheet materials by changing the width and the length thereof.

### TECHNICAL FIELD

The present invention relates to an apparatus for automatically supplying and discharging sheet materials.

### BACKGROUND ART

A sheet material is generally provided as a roll. In order to process the sheet material, the sheet material is unrolled from the roll and the unrolled sheet is conveyed to a processing machine such as a steel sheet processing machine. The processing machine divides the sheet material into various shaped sheets and stacks the divided sheets according to the size. Then, the stacked sheet is conveyed to a loading place, generally. After dividing the unrolled sheet, the processing machine may discharge the divided sheet.

A roller conveyer or a belt conveyer is generally used as a conventional apparatus for supplying and discharging a sheet material. Hereinafter, the roller conveyer is used as an example of the conventional apparatus for supplying and discharging the sheet material.

FIG. 1 is a view showing a roller conveyer as a conventional apparatus for supplying and discharging a sheet material. As shown in FIG. 1, various sheet materials 20 having different sizes and shapes are loaded on the roller conveyer 10. The roller conveyer 10 is rotated by a driving force made by either of a human or a machine to convey the sheet materials 20 to a loading place or a discharging place.

Such a roller conveyer supplies or discharges the sheet materials according to the order of loading the sheet materials on the roller conveyer. That is, the roller conveyer discharges the sheet materials in a sequence that the sheet materials are loaded on the roller conveyer. Therefore, there are difficulties to automatically supply or discharge sheet materials according to a target size or shape when various sheet materials having different lengths and widths are loaded on the random place of the roller conveyer.

### DISCLOSURE OF INVENTION

### Technical Problem

It is, therefore, an object of the present invention to provide an automatic sheet material supplying and discharging apparatus having an improved structure to automatically, economically, quickly, and efficiently supply and discharge sheet materials having various sizes.

### Technical Solution

In accordance with one aspect of the present invention, there is an apparatus for automatically supplying and discharging a sheet material including: a moving frame including a plurality of legs facing one another and traveling along a x-axis guide line and a y-axis guide line; a lifting bar installed at each of the legs for being risen and fallen; and a holder disposed at the lifting bar for lifting up the sheet material.

The lifting bar may be raised and fallen by one of an air pressure cylinder and an oil pressure cylinder installed inside the leg.

The plurality of lifting bars may be independently raised and fallen.

The holder may be operated by one of the air pressure cylinder and the oil pressure cylinder installed in the lifting bar, and the holder may include a plurality of joints connected through a hinge where each of the joints is independently folded.

### ADVANTAGEOUS EFFECTS

An apparatus for automatically supplying and discharging sheet materials according to the present invention economically, quickly, and efficiently supplies or discharges sheet materials without regarding to an order of loading sheet materials having various sizes and shapes by changing the width and the length thereof.

### BRIEF DESCRIPTION OF THE DRAWINGS

The above and other objects and features of the present invention will become apparent from the following description of the preferred embodiments given in conjunction with the accompanying drawings, in which:

FIG. 1 is a view showing a conventional apparatus for supplying and discharging sheet materials;

FIG. 2 is a perspective view illustrating an apparatus for supplying and discharging sheet materials according to an embodiment of the present invention; and

FIGS. 3 through 7 show the apparatus for supplying and discharging sheet materials shown in FIG. 2 for describing the operations thereof.

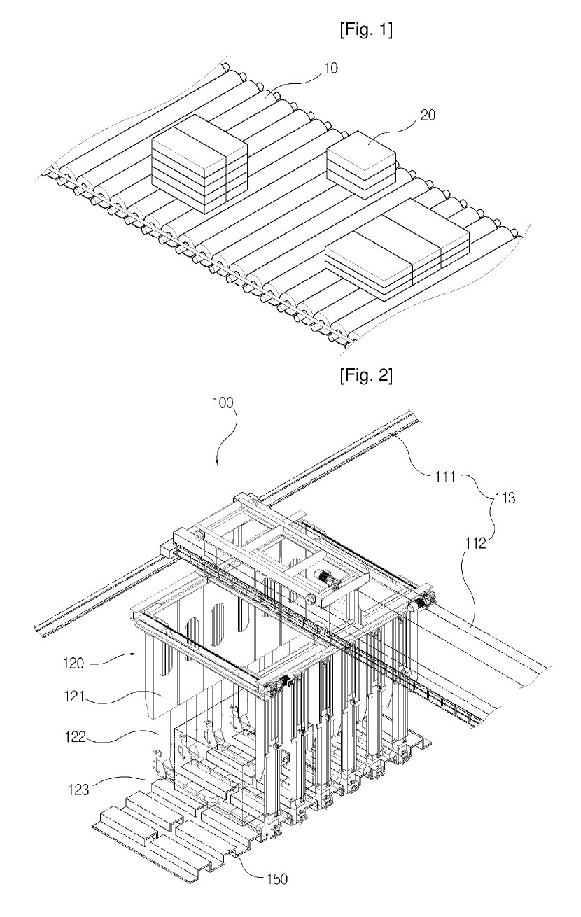

### BEST MODE FOR CARRYING OUT THE INVENTION

Other objects and aspects of the invention will become apparent from the following description of the embodiments with reference to the accompanying drawings, which is set forth hereinafter.

FIG. 2 is a perspective view of an apparatus for automatically supplying and discharging sheet materials according to an embodiment of the present invention.

Referring to FIG. 2, the apparatus for automatically supplying and discharging sheet materials according to the present embodiment includes a moving frame 120, a lifting bar 122 and a holder 123.

The moving frame 120 travels along a guide line 113 including an X-axis guide line 111 or Y-axis guide line 112. The moving frame 120 also includes a plurality of legs 121 facing one another. Each of legs 121 includes an oil pressure cylinder or an air pressure cylinder (not shown) inside thereof.

The moving frame 120 may be connected to a lifting device (not shown) to be risen and to be fallen in the up direction and the down direction according to a location of sheep material. As the lifting device, a wire or an oil/air pressure cylinder may be used. Also, a rotating member (not shown) may be connected between the guide line 113 and the moving frame 120 to rotate the moving frame 120.

The lifting bar 122 includes the air or oil pressure cylinder (not shown) inside thereof. A plurality of lifting bars 122 is connected to each of the plurality of legs 121 in the moving frame 120, respectively. The lifting bars 122 are raised and fallen by the air/oil pressure cylinders in the legs 121, and the lifting bars 122 installed at the legs 121 facing one another may be driven simultaneously or independently. It is decided according the width and the length of sheet material to be lifted by the holder 123 connected to the lifting bar 122. It is also possible to control the lifting bars 122 separately or simultaneously using a computerized controller (not shown).

Each of the lifting bars 122 includes a locking member (not shown) to prevent the holder 123 from being fallen due to the weight of the sheet material after the holder 123 holds the sheet material.

The holder 123 is connected to one of the oil and the air pressure cylinder of the lifting bar 122 and is housed inside the lifting bar 122. Such a holder 123 lifts the sheet material.

The lifting bar 122 generally houses the holder 123. When the sheet material is lifted up, the holder 123 comes out from the lifting bar 122 and lifts the sheet material.

After lifting and loading the sheet material at a proper location, the holder 123 enters into the lifting bar 122. Such a movement of the holder 123 is made by the oil/air pressure cylinder connected to the holder 123 and housed in the lifting bar 122.

As shown, the holder 123 includes a plurality of joints which are connected though a hinge. When the holder 123 is coming out from the lifting bar 122, each of joints of the holder 123 is independently folded to be located under the sheet material. Herein, the hinges connecting joints of the holder are rotated in one direction, only. That is, if the joints of holder are folded under the sheet material, the folded joints are not returned to the original position by the hinge because the hinge rotates in one direction, only. Therefore, the folded joints of the holder support the sheet material while the sheet material is lifted up.

One ends of holders facing one another are formed to be inclined so that they are correspondent with one another. That is, one end of the holder 123 is formed in a shape of an inclined plane of a triangle to face the outside, and one end of other holder 123 is formed in a shape of an inclined plane of a triangle to face the inside so that the inclined plane ends of the holders 123 facing one another are correspondent with each other to effectively support the weight of the sheet material.

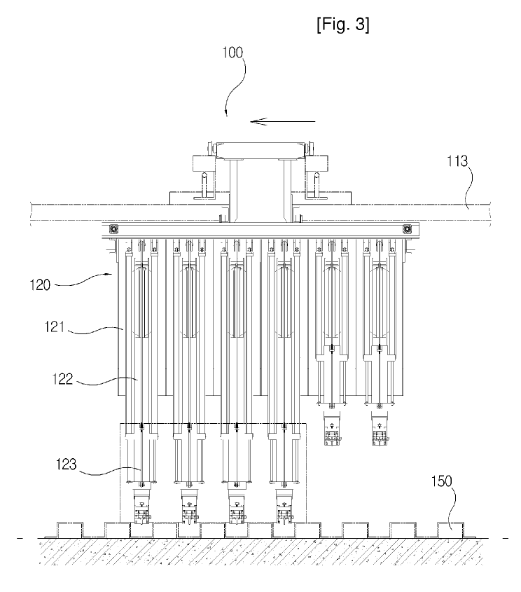

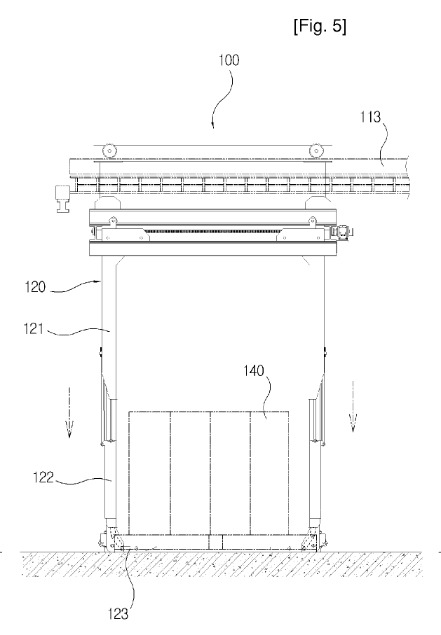

Hereinafter, operations of the apparatus for automatically supplying and discharging the sheet material according to the present embodiment will be described with reference to FIGS. 3 through 7.

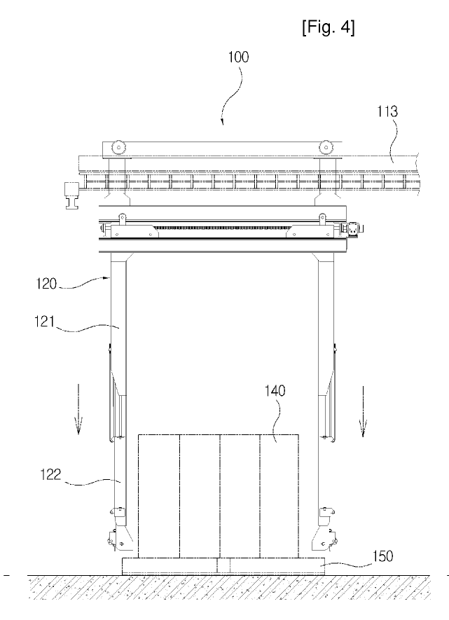

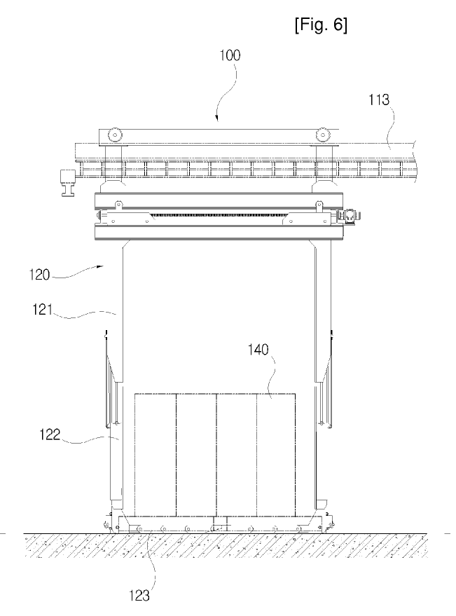

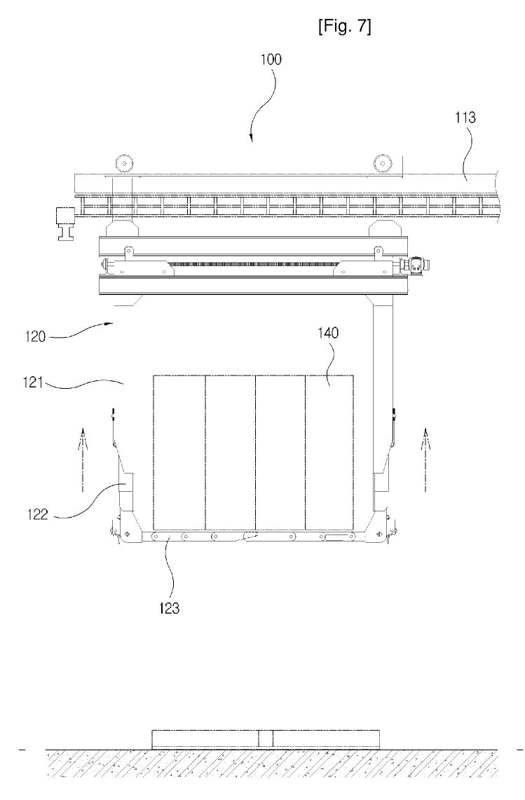

Referring to FIG. 3, the moving frame 120 moves along the guide line 113 toward the sheet material 140 in order to load the sheet materials 140 discharged from the sheet processing machine on a sheet loading place, or in order to discharge the sheet material 140 loaded on the sheet loading place. Then, all or part of lifting bars 122 are fallen according to the width and the length of the sheet material 140 as shown in FIG. 4. When a corrugate portion of the lifting bars 122 touches the surface of ground, the holder 123 come out from the lifting bars 122 and the joints of the holder 123 are folded. As a result, the folded portion of the holder 123 is inserted under the sheet material 140 as shown in FIG. 6. When the folded portion of the holder 123 is inserted under the sheet material 140, the locking member installed at the lifting bar 122 locks the holder 123 to prevent the holder 123 from being fallen in the bottom direction although the holder 123 lifts up the sheet material 140. As shown, if the holder 123 is located under the sheet material 140, the lifting bar 122 is risen as shown in FIG. 7 to lift the sheet material 140 up. Then, the moving frame 120 travels along the guide line 113 toward the target place and the sheet material is loaded or discharged on the target place. Herein, the sheet material 140 may be loaded on a pallet 150. The pallet 150 includes a plurality of convex units and concave units arranged in alternative fashion as shown in FIGS. 2 and 3. Therefore, the holders 123 are inserted under the convex units of the pallet 150 arranged with a predetermined space to lift up the pallet 150 and the sheet material 140 at the same time. Or, the holders 123 are inserted on the concave units to lift up the sheet material 140, only.

As described above, the apparatus for automatically supplying and discharging the sheet material according to the present invention effectively supplies and discharges various sheet materials having different sizes without regarding to the order of loading the sheet materials by changing the width and the length thereof.

While the present invention has been described with respect to certain preferred embodiments, it will be apparent to those skilled in the art that various changes and modifications may be made without departing from the scope of the invention as defined in the following claims.

1. An apparatus for automatically supplying and discharging a sheet material comprising:
a moving frame including a plurality of legs facing one another and traveling along an x-axis guide line and a y-axis guide line;
a lifting bar installed at each of the legs for being risen and fallen; and
a holder disposed at the lifting bar for lifting up the sheet material.

2. The apparatus of claim 1, wherein the lifting bar is raised and fallen by one of an air pressure cylinder and an oil pressure cylinder installed inside the leg.

3. The apparatus of claim 1, wherein the plurality of lifting bars are independently raised and fallen.

4. The apparatus of claim 1, wherein the holder is operated by one of the air pressure cylinder and the oil pressure cylinder installed in the lifting bar, and the holder includes a plurality of joints connected through a hinge where each of the joints is independently folded.
